(19) United States
(12) Patent Application Publication
(10) Pub. No.: US 2010/0040995 A1
(43) Pub. Date: Feb. 18, 2010

(54) Applicator Device

(75) Inventors: Frank Müller, Feldkirch (AT); Gabriele David, Lindau (DE)

Correspondence Address: John C. Thompson, 69 Grayton Road, Tonawanda, NY, 14150, US

(73) Assignee: Ivoclar Vivadent AG

(21) Appl. No.: 12/462,747

(22) Filed: Aug. 7, 2009

(30) Foreign Application Priority Data
Aug. 15, 2008 (DE) 10 2008 038 887.4

(51) Int. Cl. A61C 3/00

(52) U.S. Cl. 433/141

(57) ABSTRACT

The invention relates to an applicator device (100) having a shank (10) and an applicator element. In order to further develop the applicator device (100) such that a sufficient support of the applicator element as well as its exchangeability is provided, the invention proposes that a receiving region (18) of the shank (10) is surrounded by the applicator element in the form of a shank top (11) having a positive fit, frictionally engaged, and/or actuated by adherence as well as in a releasable manner

### CROSS-REFERENCE TO RELATED APPLICATIONS

This application claims foreign priority benefits under 35 U.S.C. §119(a)-(d) from German patent application ser. no. P 10 2008 038 887.4 filed Aug. 15, 2008.

### TECHNICAL FIELD

The present invention relates to an applicator device having a shank and an applicator element, and more particularly to one used in the medical field, and in this connection, in particular, in dentistry.

### BACKGROUND OF THE INVENTION

The applicator devices known from the prior art such as U.S. Pat. No. 5,647,746 mostly exhibit the feature of having an elongated handle that at least at one end is provided with an applicator element having the form of an absorbent material for the purpose of giving or applying different dental materials or substances, respectively. In this case for example, applicator devices with a holding instrument as handle piece are provided, said applicator devices consisting of a tubular pin with absorbent materials such as a cotton pellet attached to one end.

Moreover, applicator devices known from the prior art, can comprise hinges or kinks in order to bend or deflect the free ends of an applicator device relative to the longitudinal axis of a handle piece in order to arrange a free end in a desired operating angle relative to the longitudinal axis of the handle piece. Further, there are known structural embodiments of applicator devices having a shank that is pivotally mounted, for example with the aid of a ball-and-socket joint, to the handle piece. An applicator device of this kind for example is known from US 2003/0130605 A1 that additionally states that the applicator element in the form of a sponge is fixedly connected to the shank via a supporting ring, said connection taking place in the form of a bonding.

These applicator devices known from the prior art, however, due to their structural design, have the disadvantage that the applicator elements either cannot be exchanged or, by inserting them into a recess of a shank, are not sufficiently supported on the shank of the applicator device.

### OBJECTS AND SUMMARY OF THE INVENTION

Starting out from the disadvantages stated above and appreciating the prior art disclosed of applicator devices of the kind mentioned initially, the present invention has the object of further developing an applicator device such that both a sufficient support of the applicator element and an exchangeability of the same are provided.

According to the invention, a receiving region of the shank is surrounded by the applicator element in the form of a shank top having a positive fit, frictionally engaged, and/or actuated by adherence as well as in a releasable manner. Thus, the shank top is connectable to the receiving region. The core idea of the invention is to provide an applicator element that ensures an immediate support on the shank. Due to the fact that a receiving region of the shank is surrounded by an applicator element in the form of a shank top in a positive and/or non-positive manner, an immediate support of the applicator element on the shank is provided. The applicator element according to the invention thus neither is glued to the shank nor is inserted into a recess of the shank. In the terminology used here, a part of the shank surface or the entire surface of the shank forms the receiving region, that is to say the region that immediately forms a positive and/or non-positive connection with the shank top.

Due to the fact that the detachability of the shank top from the shank is provided within the scope of the invention, the invention further complies with the urgent desire to only use an applicator element once and then dispose of it afterwards.

In this case, the receiving region of the shank can be surrounded by the shank top having a positive fit and/or actuated by adherence in such a way that the elongated portion of the receiving region is surrounded by the shank top like by a sleeve. It is also possible that the receiving region is encased by the shank top.

The shank top suitably comprises a profile at its inner side and the receiving region comprises a corresponding counter profile. In this way, a particularly simple positive and/or actuated by adherence connection of the shank top with the receiving region of the shank is achieved. In particular, it can be within the scope of the invention to provide the profile in the form of a projection and the counter profile as a recess.

In order to take into account dental applications, one advantageous embodiment of the invention further provides that the shank top is flexibly formed and at least partially is coated with a coating that has a soft surface, said coating being a flock coating or consisting of bristles.

Advantageously, the shank of the applicator device is integrally connected with a handpiece and/or there is formed a kink between the shank and the handpiece, with the aid of which the shank can be arranged in a slanted position relative to the border piece. The kink ensures that the applicator device between the shank and the handle region can be arranged in a desired operating angle relative to the longitudinal axis of the handle region.

In order to well manually handle the applicator device, a practical alternative of the invention provides that the handle region comprises a profiled surface.

It is also possible within the scope of the invention that the shank of the applicator device can be connected positively and/or non-positively with a handpiece or a driven shaft of an apparatus. In this case the apparatus may be an apparatus that is arranged externally and that is motor-driven.

According to an advantageous embodiment it is provided that the flexible top is formed of an elastomer or rubber material, and the shank at its free end has the form of a peg that is overlapped or covered by the shank top like a sleeve.

In a further advantageous embodiment it is provided that the shank top is formed in a flexible manner and in particular comprises elastomer or rubber material.

In a further advantageous embodiment it is provided that the flexible top comprises an inner contour that corresponds to the receiving region of the shank.

In a further advantageous embodiment it is provided that the flexible top and the receiving region of the shank comprise profiles, in particular at least a projection and at least one recess that engage positively.

In a further advantageous embodiment it is provided that the flexible top comprises a round and/or elliptical and/or square outer cross-section and/or has a conical shape.

In a further advantageous embodiment it is provided that the receiving region has an overdimension compared to the shank top. Preferably it is 10% to 20% larger than the inner contour such that a close fit is ensured. This close fit can further be supported by providing snap-in locking devices or undercuts.

In a further advantageous embodiment it is provided that the free end of the shank top tapers to a dot or line.

In a further advantageous embodiment it is provided that the shank top is coated at least partially with a coating having a soft surface, said coating in particular consisting of flock coating and/or bristles. This surface can be wetted with a dental liquid or serves to absorb a free-flowing or powdery medium.

In a further advantageous embodiment it is provided that the shank top can be wetted with an applicator medium, for example with a free-flowing medium.

In a further advantageous embodiment it is provided that the shank top and/or the coating are formed in different colors and/or with different haptic properties.

In a further advantageous embodiment it is provided that the shank is integrally connected to a hand piece.

In a further advantageous embodiment it is provided that a kink is formed between the shank and the receiving region, with the aid of which the shank can be brought into a slanted position relative to the receiving region, said position being in particular permanent.

In a further advantageous embodiment it is provided that the shank is connectable to the handpiece or a driven shaft of an apparatus positively and/or non-positively.

In a further advantageous embodiment it is provided that the handpiece comprises a handle region with a profiled surface.

In a further advantageous embodiment it is provided that the handpiece comprises an inscription region in an end region averted to the shank, said inscription region having a thickness that is in particular smaller than the diameter of the handpiece, and a radial width that is larger than the diameter of the shank.

### BRIEF DESCRIPTION OF THE FIGURES

Further advantages, details and features emerge from the following description of the embodiments of the invention with reference to the drawings, in which schematic illustrations show:

FIG. 1 an applicator device according to the invention;

FIG. 2 a further embodiment of the applicator device according to the invention;

FIG. 3 an end region of the applicator device according to the invention;

FIGS. 4a to 4d different embodiments of the shank top of the applicator device according to the invention; and

FIGS. 5a to 5c the nature of the inner and outer side of the shank top of the applicator device according to the invention.

### DETAILED DESCRIPTION

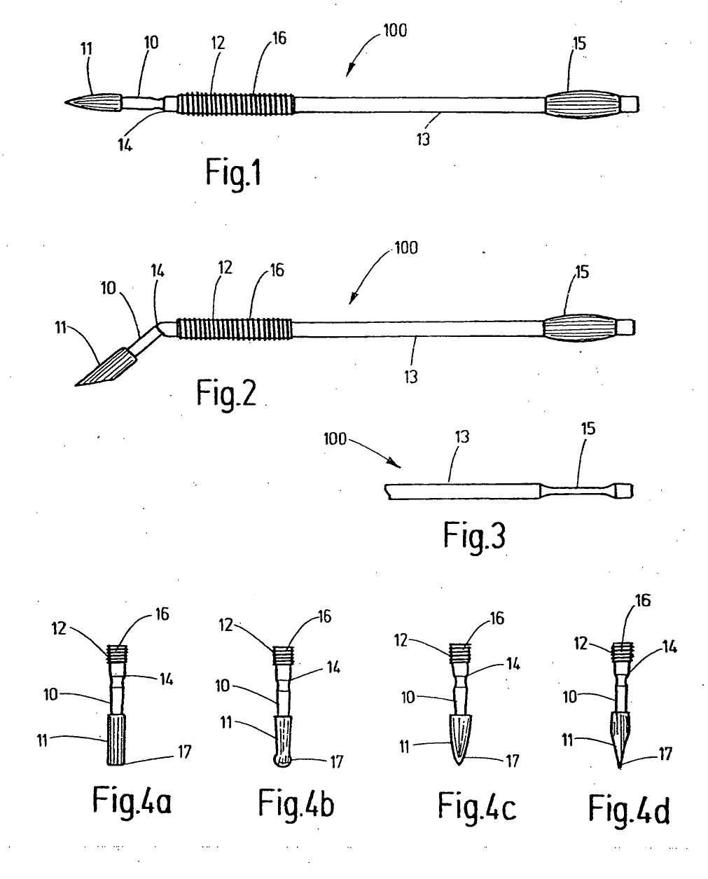

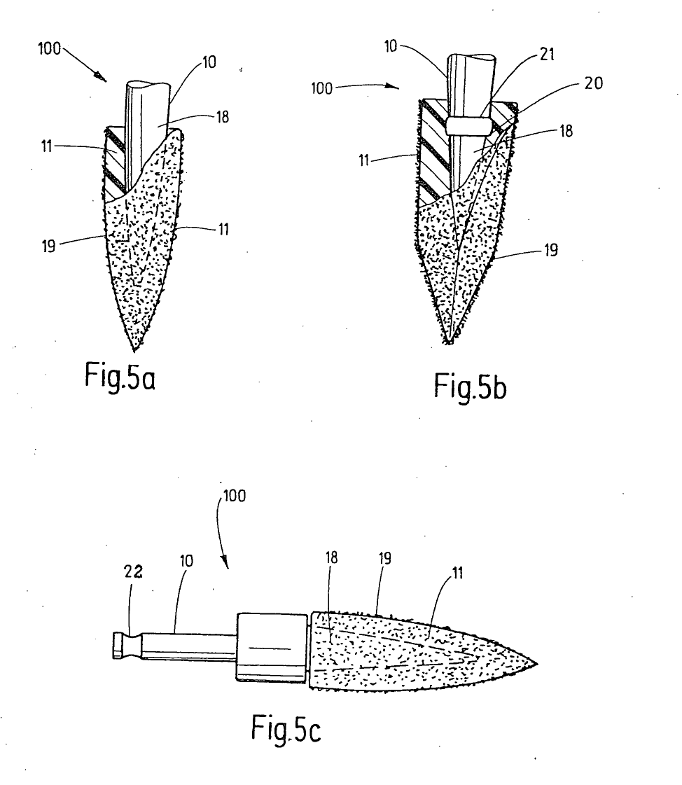

FIG. 1 illustrates an applicator device designated with the reference numeral 100. The applicator device 100 is an elongated body that further comprises a shank 10 at one end. The shank 10 on the other hand comprises a receiving region 18 shown in FIGS. 5a and 5b which is connected with the shank top 11 having a positive fit and/or actuated by adherence as well as detachably. The receiving region 18 of the shank 10 thus is in immediate contact with the inner surface of the shank top 11 (not shown in FIG. 1). The receiving region 18 thus is the surface 16 or forms part of the surface of the shank 10. A handle region 12 joins the face of the shank 10 opposing the shank top 11, the handle region 12 comprising a profiled surface 16. The handle region 12 forms part of the handpiece 13 that has a round-shaped cross-section in the embodiment shown here. A part that tapers towards the shank 10 is located between the handle region 12 and the shank 10, the tapering part acting as a kink 14 between the handle region 12 and the shank 10. As can be seen from FIG. 2, the kink is adapted such that with the aid thereof the shank 10 can be arranged in a slanted or inclined manner relative to the handpiece 13. In this case the kink 14 can be pin-jointed to the handpiece 13 or it can be of flexible and thin nature.

From FIGS. 1 and 2 it can further be seen that the handpiece 13 comprises a region 15 in an end region averted to the shank 10 whose width measured in the radial direction is larger than the diameter of the shank 10. FIG. 3 illustrates schematically and in sideview that the region 15 moreover comprises a thickness that is smaller than the diameter of the handpiece 13. The handle region 12 and the handpiece 13 as well as the region 15 are formed integrally or in one part. The region 15 can serve as an inscription region in order to provide the applicator device 100 with various inscriptions. The FIGS. 1 and 2 further illustrate that the handle region 12 has a larger outer diameter than the remaining part of the handpiece 13. The shank 10 and the handpiece 13 can be made of plastic, in particular polypropylene, respectively. The applicator device 100 thus is characterized among other things in that the shank top 11 is mounted on the shank 10 and is not inserted into the shank 10.

From FIGS. 4a to 4d it becomes apparent that the shank top 11 that is mounted on the shank 10, can have different shapes. The embodiments of the shank top 11 shown in the FIGS. 4a to 4d illustrate that the outer contour of the shank top 11 is round whereas the free end 17 of the shank top 11 tapers towards a point (FIG. 4c) or a line (FIG. 4d). In addition to being round, it may be elliptical or of a square outer cross-section. As can be seen from FIGS. 4a and 4b, the shank top 11 at its free end 17 can further have a cross-section (FIG. 4a) that conforms to the cross-section of the shank 10 or it can comprise a widening or expansion that is substantially spherical (FIG. 4b).

The FIGS. 5a to 5c that each show a partial section of the applicator device 100, illustrate that the receiving region 18 is in direct contact with the shank top 11. The shank top 11 is mounted on the shank 10 is such a manner that the shank top 11 envelops the shank 10. The shank 10 is embodied such that it forms a peg or tappet at its free end. The shank top 11 is formed in a flexible manner, the shank top 11 being provided with a profile and the receiving region 18 of the shank 10 being provided with a corresponding counter profile. Profile and counter profile can also be provided in the form of a projection 21 and a recess 20, as can be seen in FIG. 5b. The shank top 11 that can be made of an elastomer or rubber, at least partially is coated with a coating 19 having a soft surface. The coating 19 can be a flock coating and/or consist of bristles.

The present invention in its embodiment is not limited to the preferred exemplary embodiments stated above. It is rather conceivable to use a number of alternatives that also make use of the solution offered in embodiments that differ basically. It is thus possible, to additionally wet the flock coating and/or the bristles for example with a dental liquid or they may serve to absorb a free-flowing or powdery medium. Further, it is also possible that, as shown in FIG. 5c, in the region of the kink 14 a connecting groove 22 is formed that serves to form a connection to the handpiece 13. Further, the shank top 11 can have various outer contours, for example it can have elliptical, angular, pyramidal or conical shape.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. Applicator device, in particular for dental applications, said applicator device comprising a shank with an applicator element having a soft, outer surface that is releasably mounted on a receiving region of said shank, characterized in that the applicator element is formed of a flexible shank top (11) that can be connected to the receiving region (18) frictionally engaged and/or having a positive fit and/or actuated by adherence.

2. Applicator device as claimed in claim 1, wherein the shank top (11) is formed of an elastomer or rubber-like material.

3. Applicator device as claimed in claim 1, wherein the flexible top (11) is provided with an inner contour that corresponds to the receiving region (18) of the shank (10).

4. Applicator device as claimed in claim 1, wherein the flexible top and the receiving region (18) of the shank (10) comprise profiles, in particular at least a projection (21) and at least one recess (20) that engage positively.

5. Applicator device as claimed in claim 1, wherein the flexible top comprises a round cross-section.

6. Applicator device as claimed in claim 1, wherein the flexible top comprises a elliptical cross-section.

7. Applicator device as claimed in claim 1, wherein the flexible top comprises a square cross-section.

8. Applicator device as claimed in claim 1, wherein the receiving region (18) has an overdimension compared to the shank top (11) facilitating a press fit connection to one another.

9. Applicator device as claimed in claim 1, wherein the free end of the shank top (11) tapers to a point.

10. Applicator device as claimed in claim 1, wherein the free end of the shank top (11) tapers to a line.

11. Applicator device as claimed in claim 1, wherein the shank top (11) is coated at least partially with a coating (19) having a soft surface, said coating in particular consisting of flock coating and/or bristles.

12. Applicator device as claimed in claim 1, wherein the shank top (11) can be wetted with an applicator medium, for example with a free-flowing medium.

13. Applicator device as claimed in claim 1, wherein the shank top (11) and/or the coating are formed in different colors and/or with different haptic properties.

14. Applicator device as claimed in claim 1, wherein the shank (10) is integrally connected with a handpiece (13).

15. Applicator device as claimed in claim 1, wherein a kink (14) is formed between the shank (10) and the receiving region (18), with the aid of which the shank (10) can be brought into a slanted position relative to the receiving region (13), said position being in particular permanent.

16. Applicator device as claimed in claim 1, wherein the shank (10) is connectable to the handpiece (13) or a driven shaft of an apparatus positively and/or non-positively.

17. Applicator device as claimed in claim 12, wherein the handpiece (13) comprises a handle region with a profiled surface.

18. Applicator device as claimed in one claim 12, wherein the handpiece (13) comprises an inscription region in an end region averted to the shank (10), said inscription region having a thickness that is in particular smaller than the diameter of the handpiece (13), and a radial width that is larger than the diameter of the shank (10).

19. Applicator device as claimed in claim 1 wherein the flexible top comprises a conical shape.
